(19) United States
(12) Patent Application Publication
(10) Pub. No.: US 2015/0348259 A1
(43) Pub. Date: Dec. 3, 2015

(54) QUANTITATIVE METHOD FOR 3-D BONE MINERAL DENSITY VISUALIZATION AND MONITORING

(71) Applicant: Carestream Health, Inc., Rochester, NY (US)

(72) Inventors: Andre Souza, Webster, NY (US); Lawrence A. Ray, Rochester, NY (US); Alexandre X. Falcao, Campinas SP (San Paulo) (BR)

(21) Appl. No.: 14/310,193

(22) Filed: Jun. 20, 2014

Related U.S. Application Data
(60) Provisional application No. 62/006,931, filed on Jun. 3, 2014.

(51) Int. Cl. G06T 7/00; G06K 9/46; G06T 15/08; G06T 15/10

(52) U.S. Cl. CPC G06T 7/0012; G06T 7/0081; G06T 15/10; G06K 9/46; G06T 15/08; G06K 2009/4666; G06T 2207/30008

(57) ABSTRACT

A method for reporting bone mineral density values for a patient, the method executed at least in part by a computer includes accessing a 3-D volume image that includes at least bone content and background. A 3-D bone region is automatically segmented from the background to generate a 3-D bone volume image having a plurality of voxels. One or more bone mineral density values are computed from voxel values of the 3-D bone volume image. A 3-D mapping of the one or more computed bone mineral density values is generated and displayed, stored, or transmitted.

### CROSS REFERENCE TO RELATED APPLICATIONS

This application claims the benefit of U.S. Provisional application U.S. Ser. No. 62/006,931, provisionally filed on Jun. 3, 2014, entitled “QUANTITATIVE METHOD FOR 3-D BONE MINERAL DENSITY VISUALIZATION AND MONITORING”, in the names of Andre Souza et al., incorporated herein in its entirety.

### TECHNICAL FIELD

The disclosure relates generally to the field of medical imaging and more particularly to quantitative methods for generating and displaying statistical data from attenuation data generated by volume image reconstruction.

### BACKGROUND

Measurements of bone mineral density (BMD) are useful in detection of osteoporosis and related conditions and BMD data can be of particular value for guiding treatment of patients at risk from such conditions. BMD measurements for this purpose are obtained from bone mineral content of trabecular bone (calcium hydroxyapatite), rather than from the denser cortical bone.

Trabecular or spongy bone has a number of characteristics that distinguish it from cortical or compact bone that is optimized for skeletal support. Trabecular bone has a higher surface area to mass ratio than cortical bone and is generally softer and more flexible. Trabecular bone structure is typically found at the ends of long bones, proximal to joints and within the interior of vertebrae. This type of bone material is highly vascular and frequently contains red bone marrow and other biological materials and provides space for a considerable amount of metabolic activity, including calcium ion exchange. Trabecular bone is characterized by tiny lattice-shaped spicules.

Among conventional methods for BMD analysis are dual-energy X-ray absorptiometry (DEXA or DXA). DXA uses conventional X-ray equipment, has low to moderate radiation dose requirements, and is considered to be a cost-effective imaging solution for BMD assessment in some cases. However, DXA has a number of inherent limitations and could leave the practitioner without sufficient information on BMD under some conditions. DXA readings can have compromised accuracy based on factors not directly related to bone density, such as patient age, presence of adipose tissue, bone size, and patient height. DXA provides only 2-dimensional (2-D) or areal density data (aBMD data), which yields, at best, only a coarse approximation of true density in terms of approximate mg/cm². DXA computations are constrained to 2-D data; full volume data is not available and some level of approximation must be used. Its inability to effectively distinguish cortical from trabecular bone information compromises the accuracy of the DXA approach. In some cases, the DXA value is a global index that is indicative of the overall bone mineral density computed for a particular patient.

U.S. Pat. No. 7,848,551 (Andersson) describes a method for analyzing bone density from 2-D image content.

Quantitative computed tomography (QCT) bone densitometry has been used for measuring bone density. QCT generally refers to densitometry applied to images of the hip and spine regions. A related method, sometimes termed peripheral QCT or pQCT, measures density for extremities, such as for forearms or legs.

Both QCT and peripheral QCT (pQCT), because they obtain volume imaging data that shows the distribution of radiation attenuation coefficients for the subject tissue, provide more accurate information on BMD and other bone-related conditions than DXA obtains. QCT results provide density information that can be processed to provide volumetric bone mineral density (vBMD) data in terms of mg/cm³ or, alternately, bone mineral content (BMC) in mg.

Although some believe that QCT and pQCT technologies have advantages over the more conventional DXA approaches for providing BMD information, there are technical hurdles that complicate QCT methods. In order to obtain increased precision of measured bone mineral density data for a particular patient from Hounsfield units (HU) of a calibrated volume, QCT simultaneously images both the patient and a reference phantom. Tools for quantitative monitoring and 3-D visualization of the acquired data remain fairly primitive; as a result, assessment of the volume data for BMD takes expertise and can require considerable effort from the practitioner.

A paper entitled “Comparison of QCT-derived and DXA-derived areal bone mineral density and T scores” by C. C. Khoo, K. Brown, C. Cann, K. Zhu, S. Henzell, V. Low, S. Gustafsson, R. I. Price, and R. L. Prince, in Osteoporos International (2009) 1539-1545 describes computation of T score values from QCT data corresponding to areal BMD values for a defined set of regions of interest (ROI). The QCT data is transformed to aBMD values that can then be assessed using digital processing.

Another paper entitled “Bone Densities and Bone Size at the Distal Radius in Healthy Children and Adolescents: A Study Using Peripheral Quantitative Computed Tomography” by C. M. Neu, F. Manz, F Rauch, A. Merkel. and E. Schoenau in Bone, vol. 28 no. 2 describes results obtained from QCT measurements of the distal radius (forearm).

Reporting of T-scores and Z-scores, as provided by conventional systems and using the systems described in the Khoo et al. and Neu et al. references cited above, provides overall information on patient condition with respect to bone density. However, these conventional systems provide merely text or chart data and do not provide utilities that allow quick visual evaluation and comparison of bone density information.

Applicants have recognized a need for presenting the 3-D BMD data for a patient in a form that readily maps visually to the patient's anatomy. Applicants have recognized a need for providing an effective, reproducible, and clinically practicable workflow for continuously monitoring and analyzing BMD data to show information related to the rate of change in a patient's condition over time. Applicants have recognized a need for quantitative monitoring and 3-D visualization tools that support QCT for obtaining and presenting information on bone mineral density.

### SUMMARY

An object of the present disclosure is to address the need for improved tools for assessment, monitoring and 3-D visualization of BMD results from volume imaging data. Embodiments described herein allow monitoring of local and global changes to BMD based on Hounsfield unit data gathered at specific anatomical locations.

These objects are given only by way of illustrative example, and such objects may be exemplary of one or more embodiments of the disclosure. Other desirable objectives and advantages inherently achieved by the may occur or become apparent to those skilled in the art. The invention is defined by the appended claims.

According to one aspect of the disclosure, there is provided a method for reporting bone mineral density values for a patient, the method executed at least in part by a computer and comprising: accessing a 3-D volume image that includes at least bone content and background; automatically segmenting a 3-D bone region from the background to generate a 3-D bone volume image having a plurality of voxels, each of the image voxels having an image value. One or more bone mineral density values are computed from voxel values of the 3-D bone volume image; a 3-D mapping of the one or more computed bone mineral density values is generated; and the generated 3-D mapping is displayed, stored, or transmitted.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a block diagram schematic that shows how projection images for generating a CT image are obtained.

FIG. 2 is a logic flow diagram showing steps for generating and displaying bone mineral density data.

FIG. 3 is a logic flow diagram showing steps for segmentation to detect the bone volume.

FIG. 4A is a logic flow diagram showing steps for computing BMD and BMC statistics, and generating a 3-D visualization.

FIG. 4B is a schematic cross section that shows the spatial relationship of trabecular bone mass, trabecular bone shell, and cortical bone.

FIG. 5A shows parts of a display with various graphical elements that show bone density related data for a 3-D trabecular bone volume image.

FIG. 5B shows parts of a display for showing bone density related data for a 3-D trabecular bone volume image using an alternate portion of the patient anatomy.

FIG. 6 is a graph showing a histogram of volumetric bone mineral density values.

FIG. 7 shows different 2-D views of a trabecular surface model in an exemplary display.

FIG. 8 shows a display for BMD visualization using an operator interface utility for values selection.

FIG. 9A shows a display for BMD visualization using an operator interface utility for values selection.

FIG. 9B is an example that shows the use of the operator interface utility.

FIG. 10 shows a 2-D slice of the 3-D volume image, defined using a plane and encoded with aBMD values.

FIG. 11A shows a display of BMD values for a patient at two different times, shown as histograms.

FIG. 11B shows a display format with an overlapped histogram.

FIG. 11C shows display of earlier, later, and difference images.

### DETAILED DESCRIPTION OF THE EMBODIMENTS

The following is a detailed description of the preferred embodiments, reference being made to the drawings in which the same reference numerals identify the same elements of structure in each of the several figures.

In the drawings and text that follow, like components are designated with like reference numerals, and similar descriptions concerning components and arrangement or interaction of components already described are omitted. Where they are used, the terms “first”, “second”, and so on, do not necessarily denote any ordinal or priority relation, but are simply used to more clearly distinguish one element from another.

In the context of the present disclosure, the term “volume image” is synonymous with the terms “3-dimensional image” or “3-D image”. For the image processing steps described herein, the terms “pixels” for picture image data elements, conventionally used with respect 2-D imaging and image display, and “voxels” for volume image data elements, often used with respect to 3-D imaging, can be used interchangeably. It should be noted that the 3-D volume image is itself synthesized from image data obtained as pixels on a 2-D sensor array and displays as a 2-D image from some angle of view. Because of this relationship, 2-D image processing and image analysis techniques can often be applied in some way to the 3-D volume image data. In the description that follows, techniques described as operating upon pixels may alternately be described as operating upon the 3-D voxel data that is stored and represented in the form of 2-D pixel data for display. In the same way, techniques that operate upon voxel data values can also be described as operating upon pixels.

In the context of the present disclosure, the term “image” refers to multi-dimensional image data that is composed of discrete image elements. For 2-D images, the discrete image elements are picture elements, or pixels. The pixel has a data value and a position that is defined by two coordinates, typically expressed as x and y coordinates. For 3-D images, also termed volume images, the discrete image elements are volume image elements, or voxels. Each voxel has an image data value and a spatial position within the volume; the voxel position within the volume is defined by three coordinates, typically expressed as x, y, and z coordinates. Image background includes content, such as surrounding air, fluid, and tissue and, in some cases, objects lying within or outside the bone; background content is removed from consideration when performing BMD calculations and evaluation. Image foreground includes content that is of interest, such as trabecular bone content in the context of the present disclosure.

As described by Falcao, et. al. in the article entitled “The Image Foresting Transform: Theory, Algorithm, and Applications,” in IEEE Trans on Pattern Analysis and Machine Intelligence, 26 (1): 19-29, 2004), a multi-dimensional image can alternately be expressed as a set of nodes and arc-weights.

In the context of the present disclosure, the term “IFT”, also known as the Image Foresting Transform, refers to a framework that represents the image data voxels as a set of nodes and arc-weights. By employing this alternate type of data structure, the Applicants have devised a processing algorithm for processing substantial amounts of image data in the control processing unit (CPU) or graphics processing unit (GPU) that is relatively straightforward, effective, and very fast (sub-linear). In previous embodiments, IFT methods were applied to pixels in a 2-dimensional image, as described in the Falcao et al. article. However, the Applicants have found that expanding the IFT techniques to voxels of a volume image can help to provide accurate segmentation, both for bone structures overall relative to surrounding tissue, and for segmentation of trabecular from cortical bone structure.

In the context of the present disclosure, the terms “viewer”, “user”, and “operator” are considered to be equivalent terms for the person who uses the diagnostic imaging system and observes and manipulates the displayed view of the volume data.

The term “highlighting” for a displayed feature has its conventional meaning as is understood to those skilled in the information and image display arts. In general, highlighting uses some form of localized display enhancement to attract the attention of the viewer. Highlighting a portion of an image, such as an individual organ, bone, or structure, or a path from one air or fluid chamber to the next, for example, can be achieved in any of a number of ways, including, but not limited to, annotating, displaying a nearby or overlaying symbol, outlining or tracing, display in a different color or at a markedly different intensity or gray scale value than other image or information content, blinking or animation of a portion of a display, or display at higher sharpness or contrast.

By way of background, the Hounsfield unit (HU) scale is a linear transformation. The original voxel image data value, also termed a CT number or CT value, is a linear attenuation coefficient measurement for a voxel. HU calculation converts or transforms the voxel value to a value in a scale in which the radiodensity of distilled water at standard pressure and temperature (STP) is defined as zero Hounsfield units (HU), while the radiodensity of air at STP is a negative value, defined as −1000 HU. Considering a voxel with average linear attenuation coefficient μₓ, the corresponding HU value is computed by:

HU=1000×((μₓ−μ_{water})/μ_{water}),

wherein μ_{water} is the linear attenuation coefficient of water. Using this scale, a change of one Hounsfield unit represents a change of 0.1% relative to the attenuation coefficient of water because the attenuation coefficient of air is nearly zero. The extent of differences in voxel HU values relative to user-defined thresholds determines how individual voxels are classified.

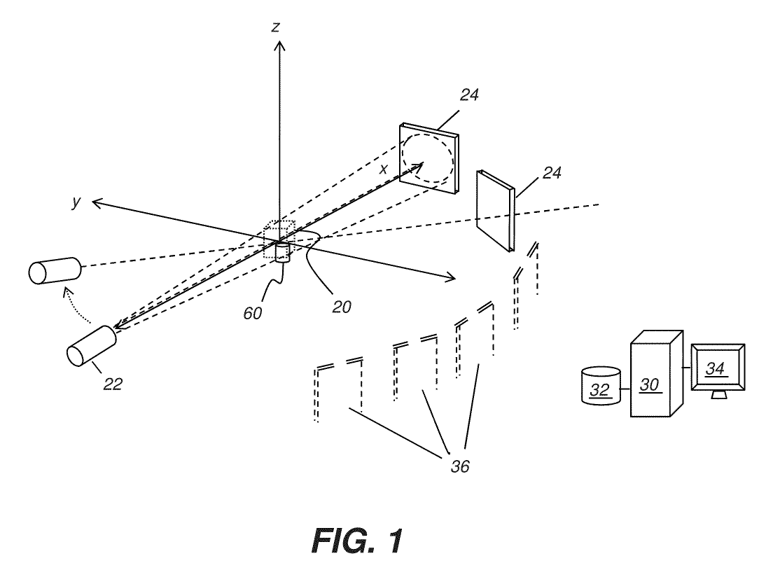

Regarding computed tomography (CT) or cone-beam computed tomography (CBCT) image capture and reconstruction, referring to the perspective view of FIG. 1, there is shown, in schematic form and using enlarged distances for clarity of description, the activity of a CT imaging apparatus for obtaining the set of individual 2-D projection images 36 that are used to form a 3-D volume image. A cone-beam or other radiation source 22 directs radiation toward a subject 20, such as a patient or other subject. A sequence of projection images 36 is obtained in succession at varying angles about the subject, such as one image at each 1-degree angle increment in a 200-degree orbit, to obtain 200 projection images 36.

A digital radiography (DR) detector 24 is moved to different imaging positions about subject 20 in concert with corresponding movement of radiation source 22. FIG. 1 shows a representative sampling of DR detector 24 positions to illustrate how these images are obtained relative to the position of subject 20. Once the 2-D projection images are captured in this sequence, a suitable imaging algorithm, such as filtered back projection (FBP) or other reconstruction technique, is used for generating the 3-D volume image. Image acquisition and program execution are performed by a computer 30 or by a networked group of computers 30 that are in image data communication with DR detectors 24. Image processing and storage is performed using a computer-accessible memory 32. The generated 3-D volume image can be presented on a display 34 and can be stored for later access in an image database, such as in a DICOM (Digital Imaging and Communications in Medicine) image storage system.

For QCT imaging, a phantom 60 is imaged along with subject 20. Data from both phantom 60 and subject 20 are correlated, allowing more accurate characterization of the volume data relative to CT numbers or Hounsfield units. The phantom 60 helps to compensate for the change in CT number values with the size of the patient and with the variable amounts of other tissues in the imaged region containing the bone. Changes in values obtained from the reference phantom are used to calibrate measurements from the patient's bone structures.

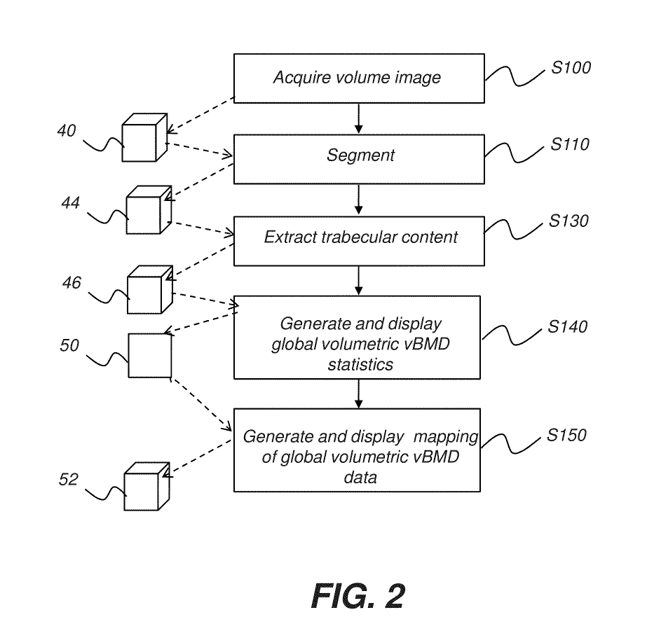

The logic flow diagram of FIG. 2 shows steps in a sequence for improved visualization of volumetric BMD statistics according to an embodiment of the present disclosure. In an image acquisition step S100, a volume image 40, having at least bone and background content, is obtained. The accessed 3-D volume image may be acquired and reconstructed directly from detector 24 or may be accessed from a database of previously stored image data. A segmentation step S110 automatically segments a 3-D bone region from the bone content in order to generate a 3-D bone volume image 44. Bone volume image 44 includes voxels for both the inner trabecular bone content that is of interest for BMD calculation and voxels for the outer, cortical bone content that is not generally used for BMD computation. As described in more detail subsequently, some of the cortical bone portions of bone volume image 44 bound trabecular bone volume image 46, with some of the cortical bone mass forming a type of outer shell that surrounds the trabecular bone content.

Continuing with FIG. 2, an extraction step S130 then automatically extracts a 3-D trabecular bone volume image 46 from within bone volume image 44. Extraction step S130 performs a type of segmentation of bone volume image 44 to obtain 3-D trabecular bone volume image 46 that excludes or removes at least a substantial portion of the denser cortical bone that surrounds the trabecular bone. In the context of the present disclosure, a substantial portion of the cortical bone is at least about 66% of the cortical bone content. In removing the cortical bone, a substantial portion of the trabecular bone is retained. In the context of the present disclosure, a substantial portion of the trabecular bone over a defined region is at least about 66% of the trabecular bone content in that region.

A statistics generation step S140 in FIG. 2 generates global volumetric bone mineral density (vBMD) statistics 50 from the 3-D trabecular bone volume image 46. In addition to volumetric vBMD statistics, the data that is generated in step S140 can also be used to generate other values related to bone mineral content (BMC), including areal aBMD statistics, as described in more detail subsequently.

According to an embodiment of the present disclosure, QCT methods and corresponding apparatus are utilized to obtain the volumetric BMD data of FIG. 2. A phantom is used for providing reference data that calibrates HU values to BMC values, as was described previously with respect to FIG. 1.

Once the volumetric statistics are generated in step S140, the values generated can be displayed in a mapping display step S150. Mapping display step S150 forms a mapping 52 to a volume image in which the color of each voxel indicates a BMD-related value, such as an intensity value that indicates the local density related to a voxel at a particular position or vBMD; alternately, the mapping can show areal aBMD or can show other computed BMC values. Mapping display step S150 can also provide information that is used for histogram display, for example. Manipulation and selection of the displayed data can provide useful information for BMD assessment.

### Segmentation Step S110

The term “segmentation” generally refers to a process that partitions an image so that particular features are well-defined and pixels or voxels that are unambiguously related to a particular feature can be labeled or identified. Segmentation step S110 automatically segments the bone 3-D content from the balance of volume image 40, providing bone volume image 44. Bone volume image 44 contains cortical as well as trabecular bone content. Segmentation of bone content from other types of tissue and from air can be performed in a number of ways.

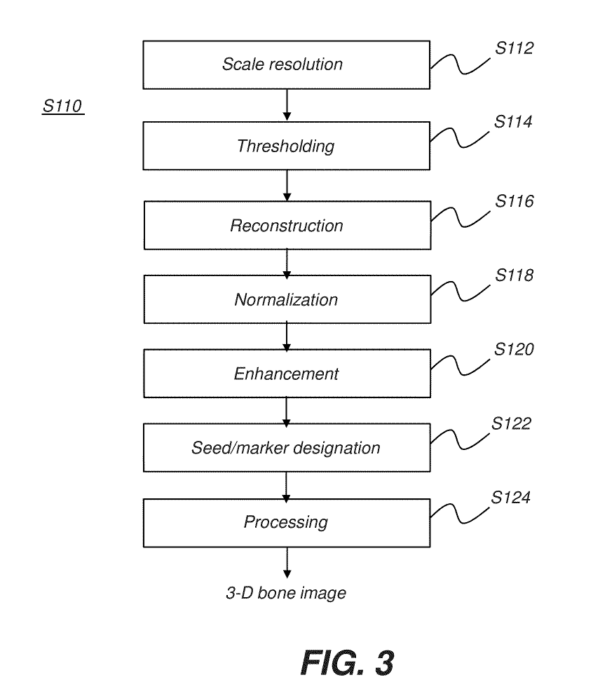

The logic flow diagram of FIG. 3 shows a set of steps that can be executed as part of segmentation step S110 according to an embodiment of the present disclosure. In an optional resolution scaling step S112, the image volume is scaled to half resolution or other reduced-resolution setting. This dramatically reduces the computational burden for the steps that follow. A thresholding step S114 then provides an automatic mask for separating background and foreground content. Thresholding methods that can be used include the Otsu method, familiar to those skilled in the art of computer vision and image processing that calculates a threshold between foreground and background by determining a threshold value that optimizes the variance between classes of voxels. The Otsu method is among threshold masking methods known to those skilled in the image processing arts. A reconstruction step S116 then corrects at least some of the thresholding anomalies, such as to provide continuous surfaces. A normalization step S118 re-maps the original HU values from the volume data to a range that allows more straightforward computation. This provides the 3-D volume in a form that is useful for subsequent refinement, segmentation, and analysis.

Continuing with the process shown in FIG. 3, an enhancement step S120 uses image enhancement techniques for enhancing bone content and for enhancing bone edges. Given the enhanced image input, a seed/marker designation step S122 automatically generates and positions seed voxels used for IFT processing. According to an alternate embodiment of the present disclosure, the user can indicate seed locations on the display. Alternately, seed voxels can be automatically identified according to computed density value and connectedness data, for example. Seed values can be selected according to Hounsfield unit values. One type of seed value indicates bone material; other seed values can indicate voxels that are clearly associated with soft tissue or with air or other background content. According to an embodiment of the present disclosure, seed values are obtained by analyzing the image data for Hounsfield values that lie within appropriate ranges. Typical HU value ranges for particular tissues include bone, with HU in excess of 200; fatty tissue, with HU between about −100 and −20; and muscle, with HU roughly between about 10 and 40 HU.

A processing step S124 then performs the segmentation to generate the 3-D bone volume, using a method such as IFT watershed segmentation, for example, using techniques that apply teaching in the Falcao et al. article cited earlier. IFT-based segmentation is advantaged because of its ability to segment multiple objects in the same operation.

It should be noted that bone mineral content and density information can be of interest for trabecular as well as for cortical bone matter. In conventional practice, BMD values relate to trabecular bone material; the surrounding cortical bone content is denser and tends to obscure the desired BMD data that is widely used for osteoporosis assessment and treatment planning. For this reason, extraction step S130 (FIG. 2) generates 3-D trabecular bone volume image 46 that excludes or removes at least a substantial portion of the surrounding cortical bone.

However, the visualization utility provided by embodiments of the present disclosure enables the practitioner to obtain more information than was previously available, both for BMD information conventionally derived from trabecular bone mass and, more broadly considered, for density information that relates to cortical bone and overall bone structure. There may be applications, for example, where it is useful to be able to visualize density information for cortical bone or for both trabecular and cortical components. In such applications, density visualization can be calculated for some portion or all of the bone volume image 44. In addition to displaying density information for a voxel at any particular position, an embodiment of the present disclosure also allows collection and display of statistical information related to bone density data.

### Generating Statistics

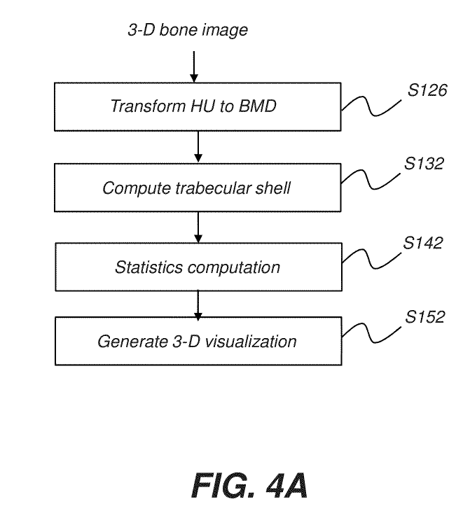

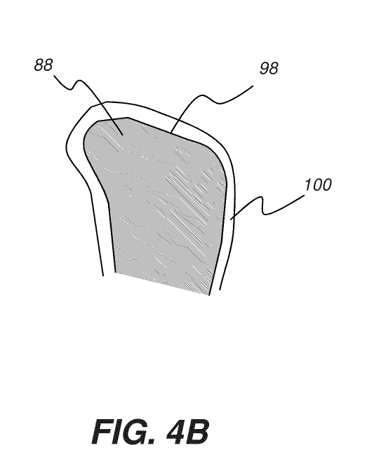

The logic flow diagram of FIG. 4A shows processing that is performed to generate and display statistical results. A transformation step S126 remaps the Hounsfield unit (HU) data to BMD values. This transformation to a BMD value is generally linear, using:

BMD=a*HU+b

wherein a is the slope of a linear regression and b represents a base value. The “*” indicates multiplication. The linear regression is obtained from the phantom that is imaged alongside the patient, as was described previously with reference to FIG. 1.

A computation step S132 computes the extent and thickness of the trabecular bone shell that defines and bounds a trabecular bone mass for the imaged anatomy. This computation helps to define a region of the bone volume that lies within and excludes cortical bone content.

FIG. 4B shows, in schematic cross section, how a trabecular bone mass 88 is bounded by trabecular bone shell 98 which, in turn, is encased within cortical bone 100. It should be noted that for BMD analysis and for generation of conventional index and statistical values, a sampling of trabecular bone mass 88 data may be all that is needed. Thus, for example, to avoid computational error that might occur if the cortical bone 100 is included in BMD computation, it may be appropriate for methods of the present disclosure to over-estimate the thickness of the cortical bone 100 shell, so that trabecular tissue that is analyzed lies well within the trabecular bone mass 88 rather than along outer edges of the trabecular region.

Continuing with the sequence of FIG. 4A, a statistics computation step S142 generates statistical values such as mean, median, mode, variance, and standard deviation useful in expressing bone mineral content. Statistics computation can generate values from any region of voxels contained in or within the trabecular bone shell. A generate visualization step S152 then provides a 3-D mapping of color, intensity, or other visual characteristic, assigned to bone volume image 44 voxels or, alternately, to trabecular bone volume image 46 voxels. A 3-D mapping can assign, to each voxel position, a color value that is indicative of the bone density at that position, for example. As shown in more detail in subsequent figures, a 3-D trabecular bone surface model can be generated as a result of generate visualization step S152.

Statistical generation step S140 in FIG. 2 can generate any of a number of useful statistics or indices that provide useful information for BMD assessment. According to an embodiment of the present disclosure, voxel density is computed as a value that is proportionate to the HU value for the voxel and that is in inverse proportion to the voxel volume. Mean, median, and mode values can be readily calculated for bone matter within a particular region of interest. A histogram showing the frequency of assigned density values can be generated as one type of computed statistical display. In addition, standard deviation, variance, and other values can similarly be computed for all voxels in an image or for voxels within a defined portion of the 3-D image and can be displayed to the viewer.

According to an alternate embodiment of the present disclosure, a statistical index such as a T-score or a Z-score is computed according to the BMD assessment data. This standardized information can be used to compare bone mineral content measurements obtained from the volume image with conventional BMD values obtained from a D×A system.

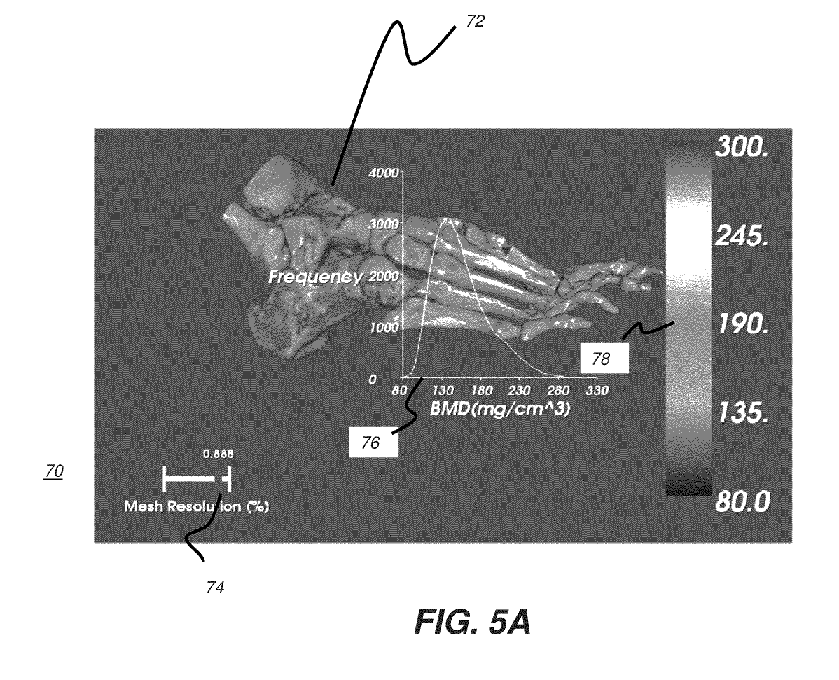

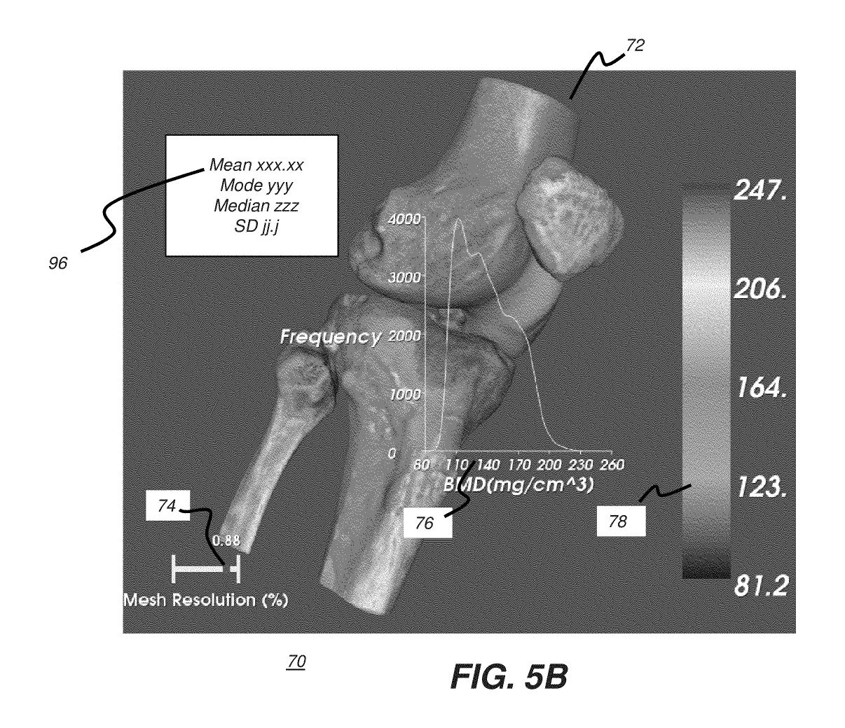

FIGS. 5A and 5B show exemplary displays of 3-D Bone Mineral Density (BMD) analysis generated in mapping display step S150 according to an embodiment of the present disclosure.

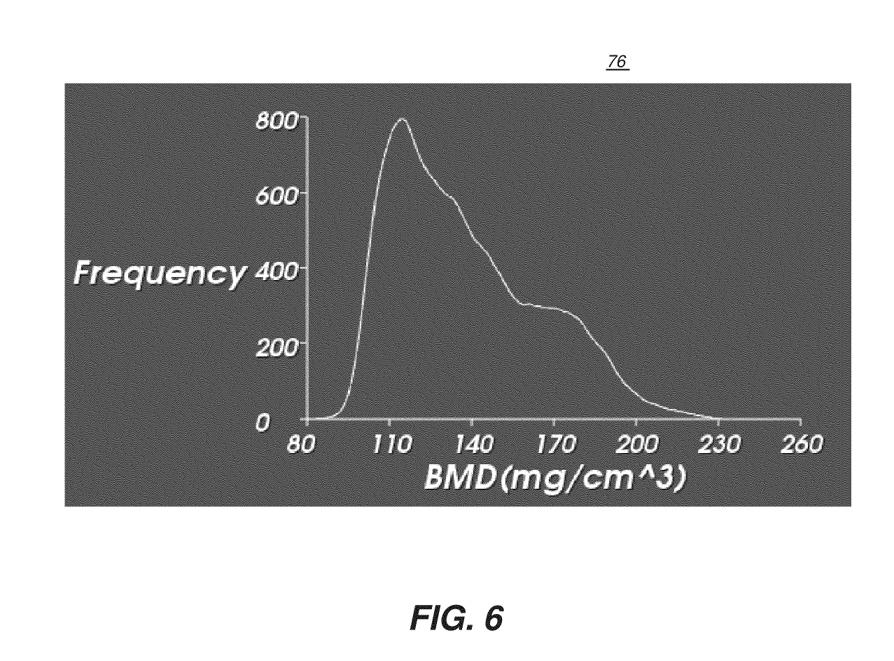

In FIGS. 5A and 5B, a display 70 shows the volume image of a 3-D trabecular bone surface model 72 with a color coding that indicates computed BMD values that have been assigned to image voxels. The color encoding that provides this visualization or mapping can alternately be a grayscale or monochrome scale encoding or a brightness or intensity encoding. An optional slidebar indicator 74 shows the resolution of image voxels. Mesh dimensions can alternately be represented. There is a histogram 76 showing the frequency of assignment of different voxel values that are indicative of bone density. A reference chart 78 relates voxel display color or grayscale or intensity to bone density values. Histogram 76 can be overlaid on the display of the 3-D trabecular bone surface model 72, as shown in FIGS. 5A and 5B or can be shown separately, as given in FIG. 6. As shown in FIG. 5B, a set of statistics 96 is also computed and displayed for the BMD data.

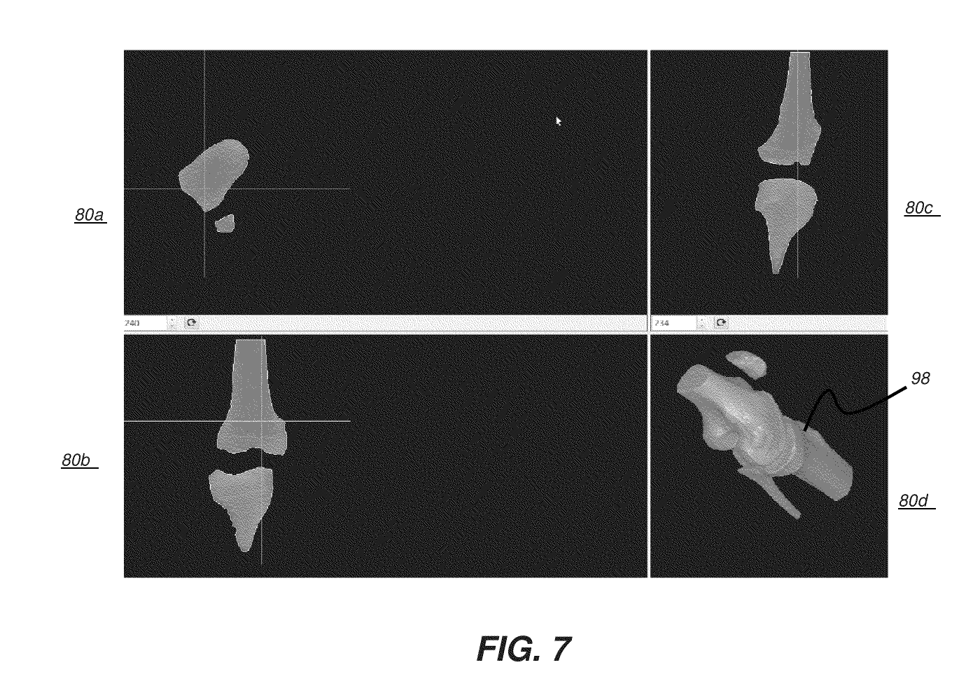

FIG. 7 shows different 2-D views 80a, 80b, 80c, and 80d of a trabecular surface model in an exemplary display. Views 80a, 80b, and 80c are orthogonal slices. View 80a is an axial view; views 80b and 80c are coronal and sagittal views. View 80d is a 3-D view showing a trabecular bone shell 98. Each of these views is of the trabecular region, with the outer cortical bone shell removed.

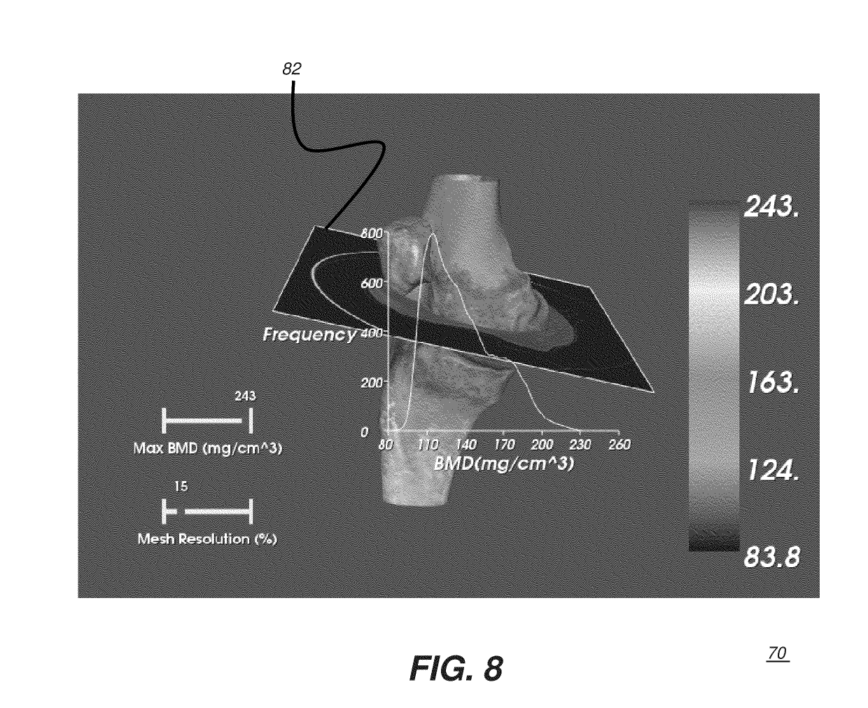

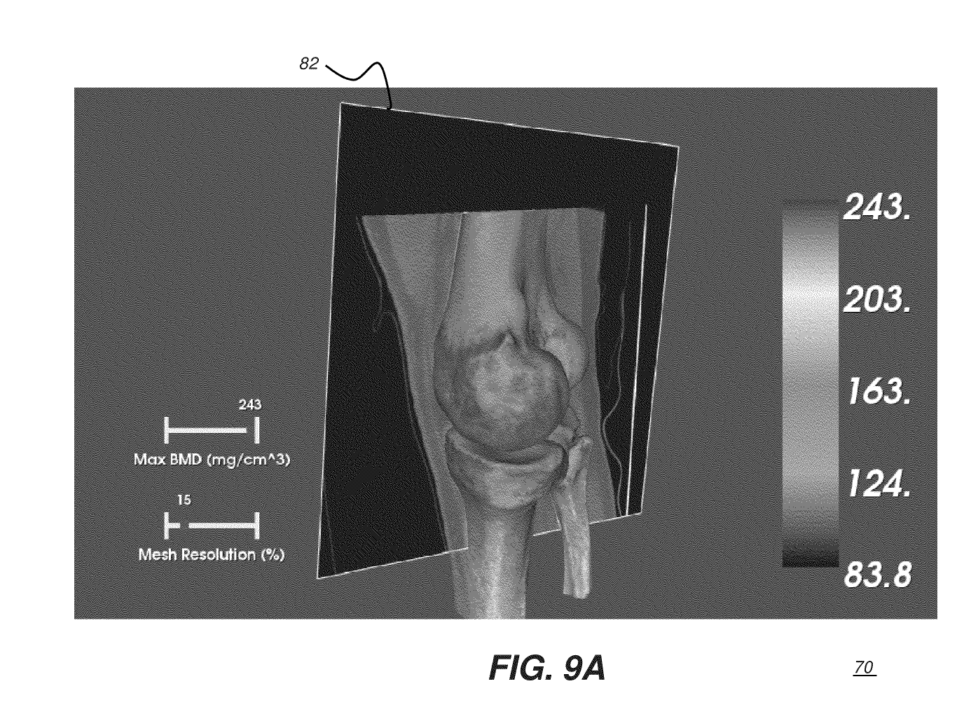

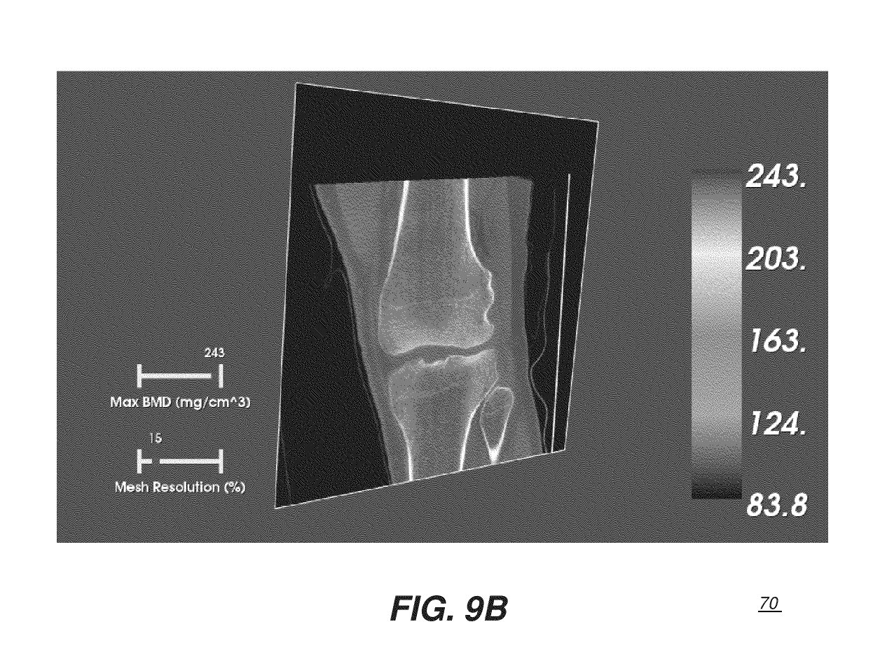

Interactive utilities can be provided for manipulating the BMD data in order to obtain more specific, localized results and to generate more localized statistics. For example, FIG. 8 shows display 70 with an operator-positionable plane 82 that allows the viewer to specify a cross-section of the volume image for analysis and statistics generation. In FIG. 8, plane 82 is positioned so that it is slightly offset from a horizontal orientation relative to the anatomy shown. FIG. 9A shows plane 82 positioned with an offset from a more vertical orientation. FIG. 9B shows the image slice that is defined with plane 82 at the position in FIG. 9A. Plane 82 can be used to define a 3-D surface of an image for calculation of volume density statistics or can be used to define a 2-D plane of the volume image for calculation of areal density statistics.

It is noted that the color, grayscale, or intensity values assigned to voxels of the volume image and displayed as shown in the examples of FIGS. 5A, 5B, 8, and 9A correspond to particular bone mineral density (BMD) values which are derived from Hounsfield values in a generally linear fashion but can differ in how they are represented. In addition, the shape of the trabecular bone features, as identified and analyzed by the methods described herein, may not have the appearance of conventional bone anatomy. This is because portions of the inner trabecular bone shell are of interest for BMD analysis and computation; the outer cortical bone that defines the standard, recognizable shape of hip, knee, or extremity may not be of interest in a particular BMD study; cortical structures may interfere with accurate BMD assessment. For these reasons, the representation of trabecular bone structure displayed by the system of the present disclosure can differ significantly from the representation of an image slice conventionally obtained from a computed tomography system.

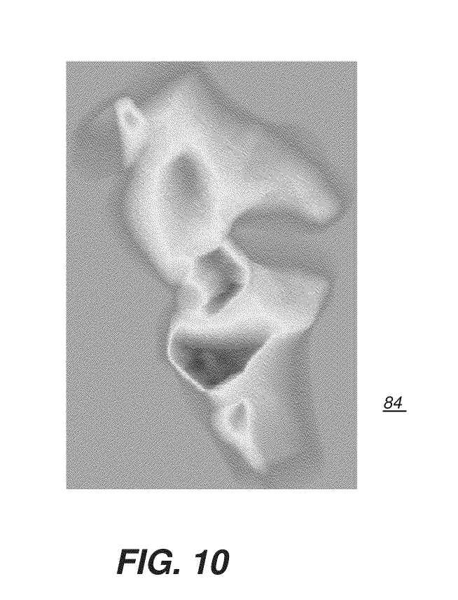

As noted previously, the bone density data that is obtained can be expressed as volumetric bone mineral density (vBMD) in mg/cm³ or as areal bone mineral density (aBMD) in mg/cm², using embodiments of the present disclosure. Areal bone mineral density values can be generated for the displayed region of the image volume, such as for an image slice that is specified as described previously with reference to FIGS. 8 and 9A. For generating areal values for a particular 2-D view, bone voxel data from the volume image can be summed along parallel projected rays, as described in the Khoo et al. reference noted previously. For comparison, the areal values obtained from a 2-D view or image slice can then alternately be mapped to corresponding aBMD values that would be generated from a D×A system, such as using look-up tables or other transformation that relates voxel or pixel values to BMD values. Appropriate color or grayscale intensity keying can be provided for either the 3-D or 2-D density values. By way of example, FIG. 10 shows a 2-D slice 84 of the 3-D volume image, defined using plane 82 as shown in the example of FIG. 9B and encoded with aBMD values.

According to an embodiment of the present disclosure, curvilinear peeling is used to define a slab or shell of a given thickness that can be used for computation and display of BMD values. The slab can be 1 voxel thick, defining a surface for display of the vBMD value for each voxel of the surface, for example. According to an alternate embodiment of the present disclosure, a thick slab is defined, with corresponding thickness parameter values dist. min and dist. max in mm to define the shell thickness.

Bone mineral content (BMC) can also be computed based on the volume BMD values obtained from the CT scan of the patient. An operator instruction can be used to initiate calculation or recalculation of vBMD or aBMD statistics, such as statistics for a particular plane (FIG. 8) or other portion of the reconstructed image.

According to an embodiment of the present disclosure, one or more global volumetric bone mineral density (vBMD) statistics are compared to a model. The generated statistics can be used to form or modify a model or fitted to a model.

### Tracking BMD Over Time

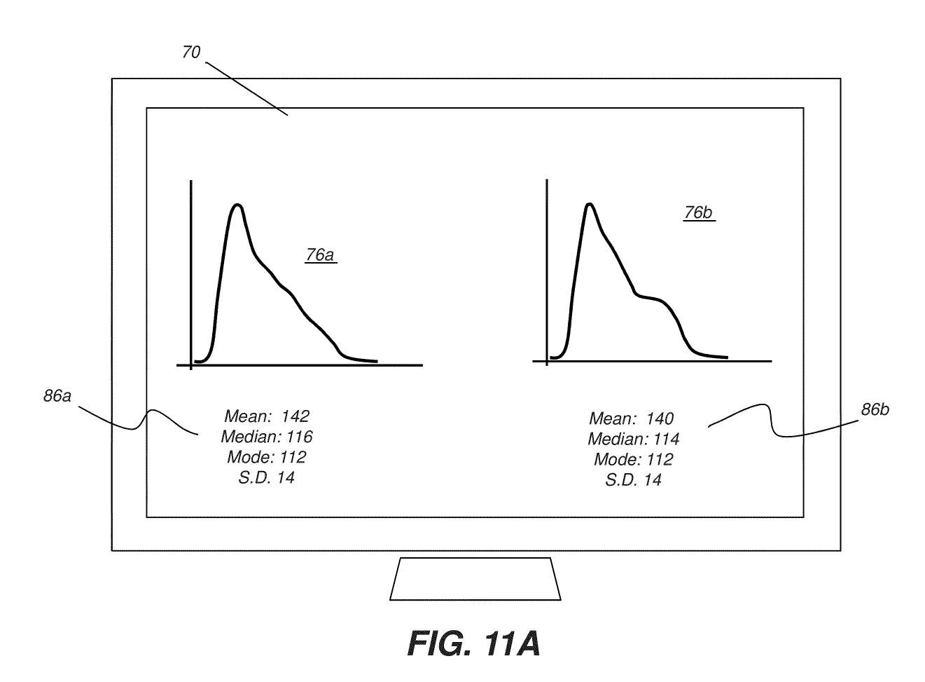

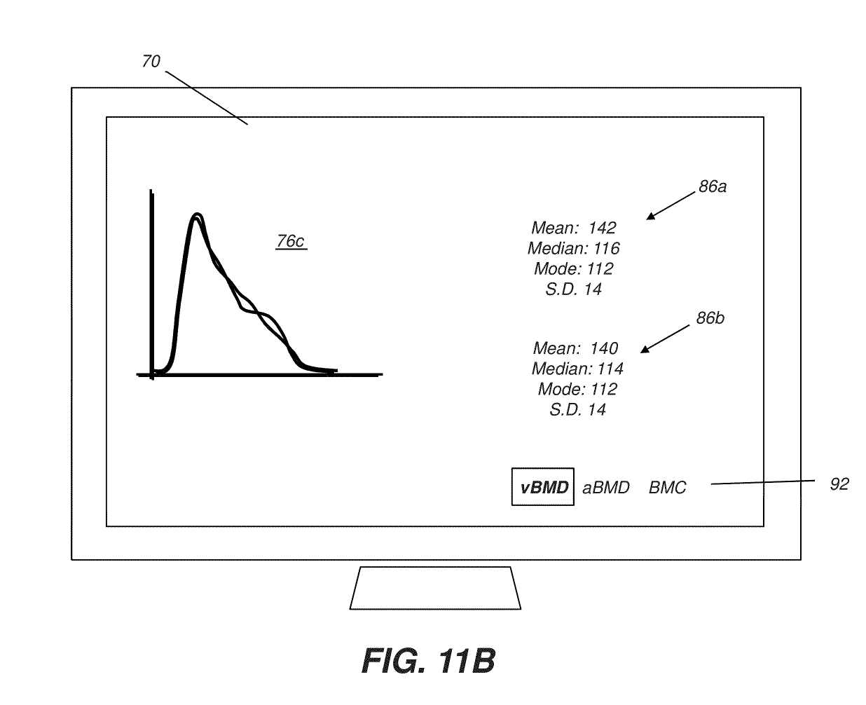

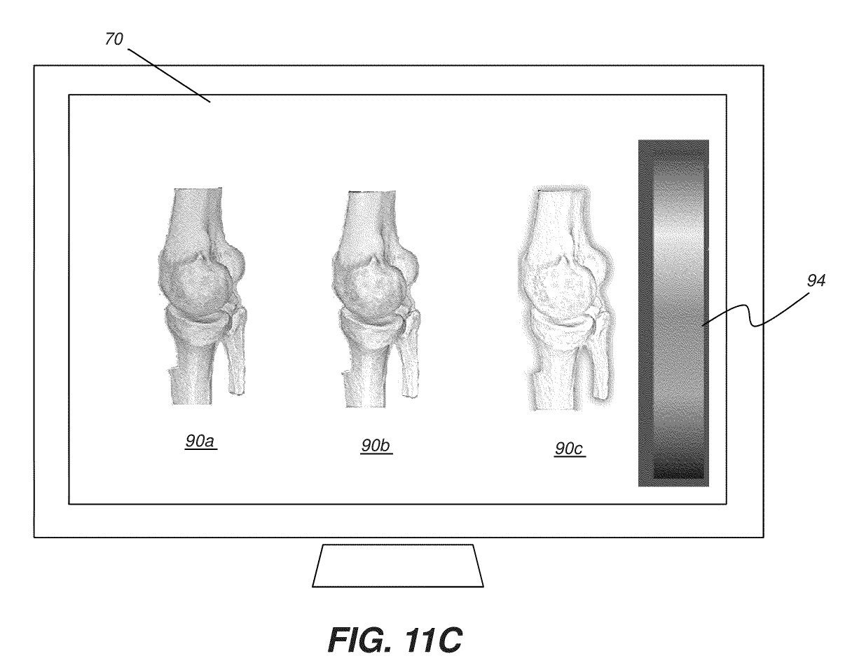

Among advantages of the BMD analysis system of the present disclosure is the capability to store data from an imaging session and to retrieve statistical information previously obtained for comparison and related analysis. By way of example, FIGS. 11A, 11B, and 11C show some alternative functions and methods of display that can be used for historical tracking and presentation of data for a particular patient. FIG. 11A shows a histogram 76a and data 86a provided for a current imaging session, displayed along with a histogram 76b and data 86b for an earlier imaging session. Data listed with the histogram can include statistical data such as mean, standard deviation, mode, median, and other values. As shown in FIG. 11B, a histogram 76c can show overlapped histogram information from an earlier and a later imaging session. An optional selector 92 allows on-screen selection of the type of data that is presented, whether aBMD, vBMD, or BMC, for example.

The display example of FIG. 11C shows images 90a and 90b from two different imaging sessions, as well as a difference image 90c that highlights the difference between results from earlier and later imaging. This type of display allows straightforward visualization of differences for a patient, allowing the practitioner to quickly ascertain how much change has occurred over time, using a key 94. For the difference image 90c, an additional step to register image content from earlier sessions must be carried out. Voxel values can be comparison values based on differences between image acquisition at different times. Registration of volume image content uses techniques familiar to those skilled in the imaging arts.

### Computer

Consistent with at least one embodiment, the system utilizes a computer program with stored instructions that perform on image data accessed from an electronic memory. As can be appreciated by those skilled in the image processing arts, a computer program of an embodiment of the present disclosure can be utilized by a suitable, general-purpose computer system, such as a personal computer or workstation. However, many other types of computer systems can be used to execute the computer program of the present disclosure, including networked processors. The computer program for performing the method of the present disclosure may be stored in a computer readable storage medium. This medium may comprise, for example; magnetic storage media such as a magnetic disk such as a hard drive or removable device or magnetic tape; optical storage media such as an optical disc, optical tape, or machine readable bar code; solid state electronic storage devices such as random access memory (RAM), or read only memory (ROM); or any other physical device or medium employed to store a computer program. The computer program for performing the method of the present disclosure may also be stored on computer readable storage medium that is connected to the image processor by way of the internet or other communication medium. Those skilled in the art will readily recognize that the equivalent of such a computer program product may also be constructed in hardware.

It should be noted that the term “memory”, equivalent to “computer-accessible memory” in the context of the present disclosure, can refer to any type of temporary or more enduring data storage workspace used for storing and operating upon image data and accessible to a computer system, including a database, such as database 50 described with reference to FIG. 5A, for example. The memory could be non-volatile, using, for example, a long-term storage medium such as magnetic or optical storage. Alternately, the memory could be of a more volatile nature, using an electronic circuit, such as random-access memory (RAM) that is used as a temporary buffer or workspace by a microprocessor or other control logic processor device. Displaying an image requires memory storage. Display data, for example, is typically stored in a temporary storage buffer that is directly associated with a display device and is periodically refreshed as needed in order to provide displayed data. This temporary storage buffer can also be considered to be a memory, as the term is used in the present disclosure. Memory is also used as the data workspace for executing and storing intermediate and final results of calculations and other processing. Computer-accessible memory can be volatile, non-volatile, or a hybrid combination of volatile and non-volatile types.

It will be understood that the computer program product of the present disclosure may make use of various image manipulation algorithms and processes that are well known. It will be further understood that the computer program product embodiment of the present disclosure may embody algorithms and processes not specifically shown or described herein that are useful for implementation. Such algorithms and processes may include conventional utilities that are within the ordinary skill of the image processing arts. Additional aspects of such algorithms and systems, and hardware and/or software for producing and otherwise processing the images or co-operating with the computer program product of the present disclosure, are not specifically shown or described herein and may be selected from such algorithms, systems, hardware, components and elements known in the art.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A method for reporting bone mineral density values for a patient, executed at least in part by a computer, comprising:
accessing a 3-D volume image that includes at least bone content and background;
automatically segmenting a 3-D bone region from the 3-D volume image to generate a 3-D bone volume image having a plurality of voxels, each of the voxels having an image value;
computing one or more bone mineral density values from the voxel image values of the 3-D bone volume image;
generating a 3-D mapping of the one or more computed bone mineral density values; and
displaying, storing, or transmitting the generated 3-D mapping.

2. The method of claim 1 wherein automatically segmenting the 3-D bone region from the bone content further comprises removing a substantial portion of the cortical bone content and retaining a substantial portion of the trabecular bone content.

3. A method for reporting bone mineral density values for a patient, executed at least in part by a computer, comprising:
accessing a 3-D volume image that includes at least bone content and background;
automatically segmenting a 3-D bone region from the 3-D volume image to generate a 3-D bone volume image having a plurality of voxels;
automatically extracting, from within the 3-D bone volume image, a 3-D trabecular bone volume image having image voxels, each of the image voxels having a value;
computing one or more bone mineral density values from voxel values of the 3-D trabecular bone volume image;
generating a 3-D mapping of the one or more computed bone mineral density values; and
displaying, storing, or transmitting the generated 3-D mapping.

4. The method of claim 3 further comprising generating and displaying one or more volumetric bone mineral density statistics generated from the one or more computed bone mineral density values.

5. The method of claim 4 further comprising storing the volumetric bone mineral density statistics from a previous imaging session and comparing them with the volumetric bone mineral density statistics generated from a later imaging session.

6. The method of claim 4 further comprising fitting the one or more volumetric bone mineral density statistics to a model.

7. The method of claim 4 further comprising generating a T-score or other index related to the one or more volumetric bone mineral density statistics for a patient.

8. The method of claim 3 further comprising generating and displaying one or more areal bone mineral density statistics generated from the one or more computed bone mineral density values.

9. The method of claim 3 further comprising displaying a histogram of the computed bone mineral density values for the 3-D trabecular bone volume image.

10. The method of claim 3 further comprising:
generating a 3-D trabecular bone surface model from the 3-D trabecular bone volume image; and
displaying the 3-D mapping onto the 3-D trabecular bone surface model.

11. The method of claim 3 further comprising accepting an operator instruction for generating the one or more volumetric bone mineral density statistics.

12. The method of claim 11 wherein the operator instruction defines a plane surface extending through the trabecular bone volume image.

13. The method of claim 3 wherein automatically extracting, from within the 3-D bone volume image, a 3-D trabecular bone volume image includes excluding a substantial portion of the voxels that are indicative of cortical bone content.

14. A method for generating bone mineral density values for a patient, executed at least in part by a computer, comprising:
accessing a 3-D volume image including at least bone content and background content;
automatically segmenting a 3-D bone region from the 3-D volume image to generate a 3-D bone volume image comprised of a plurality of image voxels, each of the plurality of image voxels having an associated Hounsfield value; and
for each of the plurality of image voxels in the 3-D bone volume image:
(i) assigning a bone density value to the voxel according to the associated Hounsfield value, wherein the assigned bone density value is related to bone mineral content of the voxel;
(ii) displaying the voxel according to the assigned bone density value.

15. The method of claim 14 wherein assigning the bone density value is done according to a mapping from Hounsfield values to bone mineral density values, wherein the mapping is obtained from imaging a phantom.

16. The method of claim 14 wherein displaying the voxel comprises conditioning the spectral content of the voxel according to the assigned density value.

17. The method of claim 14 wherein displaying the voxel comprises conditioning the intensity of the voxel according to the assigned density value.

18. The method of claim 14 further comprising identifying trabecular bone within the 3-D bone volume image and computing and displaying an index indicative of relative bone density statistics for the identified trabecular bone.

19. The method of claim 14 further comprising displaying a histogram of assigned bone density values.

20. A method for measuring bone mineral density changes for a patient, executed at least in part by a computer, comprising:
accessing a first 3-D volume image reconstructed from a first series of projection images acquired within a prior time period, wherein the first 3-D volume image includes at least bone content and background content;
automatically segmenting a first 3-D bone region from within the first 3-D volume image to generate a first 3-D bone volume image having a Hounsfield value associated with each of a plurality of voxels of the first 3-D bone volume image;
accessing a second 3-D volume image reconstructed from a second series of projection images acquired within a later time period than the prior time period, wherein the second 3-D volume image includes at least bone content and background content;
automatically segmenting a second 3-D bone region from within the second 3-D volume to generate a second 3-D bone volume image having a Hounsfield value associated with each of a plurality of voxels of the second 3-D bone volume image;
registering the first 3-D bone volume image to the second 3-D bone volume image and assigning a comparison value to each voxel of a plurality of voxels of the first and second 3-D bone volume images; and
displaying, storing, or transmitting at least a portion of the assigned comparison values.

21. The method of claim 20 further comprising segmenting trabecular bone content from the first 3-D bone volume image.
